(19) United States
(12) Patent Application Publication
(10) Pub. No.: US 2026/0213034 A1
(43) Pub. Date: Jul. 23, 2026

(54) GRATING ASSEMBLY FOR INTERFEROMETRIC X-RAY IMAGING

(71) Applicant: KONINKLIJKE PHILIPS N.V., EINDHOVEN (NL)

(72) Inventors: THOMAS KOEHLER, NORDERSTEDT (DE); STEFAN LEONHARD LOESCHER, HAMBURG (DE)

(21) Appl. No.: 19/138,791

(22) PCT Filed: Dec. 6, 2023
(86) PCT No.: PCT/EP2023/084415

§ 371 Date: Jun. 13, 2025

(30) Foreign Application Priority Data
Dec. 16, 2022 (EP) 22214176.4

(51) Int. Cl. G21K 1/06

(52) U.S. Cl. CPC G21K 1/067; G21K 2201/064; G21K 2201/067; G21K 2207/005

(57) ABSTRACT

A grating assembly (G0-G2) for interferometric X-ray imaging. The assembly (GA) comprises a carrier sheet (CS) having deposited thereon grating tiles (GT), the said sheet having edge portions (E1-E4) and a thermal expansion coefficient. Distinct from the sheet, there are stabilizer bar members (S1-S4) affixed along respective ones of the said edge portions, the stabilizer bar members having substantially the same thermal expansion coefficient as the said sheet.

### FIELD OF THE INVENTION

The invention relates to a grating assembly for interferometric X-ray imaging, and to a method of preparing manufacture of such a grating assembly, and to method of manufacturing the grating assembly.

### BACKGROUND OF THE INVENTION

Grating-based phase-contrast (PC) and/or dark-field X-ray (DAX)-imaging is a promising technology to enhance diagnostic quality of X-ray equipment, e.g., in areas of mammography, chest-radiography, and CT (computed tomography). As the name implies, grating-based imaging requires one or more (usually three) gratings as part of the imaging system. One such grating, commonly referred to as “G2”, is situated between the patient and a detector of the imaging system.

One of the most challenging problems to build a clinical imaging system based on this technology is the manufacture of a full-field G2 grating. In particular, the relatively large area of an X-ray detector for chest examinations (almost 50 cm×50 cm) is a challenge as this needs to be covered completely by the G2 grating.

Currently, one of the more mature processes to build such gratings is the LIGA process. “LIGA” is an acronym from the German for “Lithographie, Galvanoformung, Abformung” (translatable into “lithography, electroplating, and molding”). In LIGA, the grating structures are fabricated from micrometer-sized gold structures onto graphite substrates. The maximum size of state of the art gratings is about 10 cm×20 cm, due to a space-limited X-ray exposure system as well as wafer handling restrictions in the gold plating process used in the LIGA process.

The fabrication of large wafer sizes in one piece that are able to cover the X-ray detector completely is not currently available. Therefore, the current approach uses a “stitching” or tiling process to mount several small grating tiles together to cover the complete front face of an X-ray detector.

In addition, in particular in DAX or PC imaging systems, there is a need in some instances for focused gratings to reduce signal loss, in particular for large area imaging applications such as chest imaging. In such focused gratings, a cylindrical bending radius of the G2 grating is approximately 2-3 m. There is also another grating (G1′), which is also focused.

It has been found that the stability of such curved and filed grating setups may be instable and may thus lead to imaging artifacts.

### SUMMARY OF THE INVENTION

There may therefore be a need for improved grating assemblies for use in X-ray based imaging.

The object of the present invention is solved by the subject matter of the independent claims where further embodiments are incorporated in the dependent claims. It should be noted that the following described aspects of the invention equally applies to the method of preparing manufacturing the grating assembly, and the method of manufacturing the grating assembly.

According to one aspect there is provided a grating assembly for interferometric X-ray imaging, comprising:
a carrier sheet having deposited thereon at least one grating tile, the said sheet having edge portions and a thermal expansion coefficient; and
distinct from the sheet, stabilizing bar members affixed along respective ones of the said edge portions,
wherein a thermal expansion coefficient of the stabilizer bar members corresponds to the thermal expansion coefficient of the carrier sheet.

Specifically, as preferred herein, the stabilizer bar members have substantially the same thermal expansion coefficient as the said sheet, that is, are within a low tolerance range. The two thermal expansion coefficients may be equal.

The thermal expansion coefficients are very similar, preferably at intended operation temperature when in use in imaging. A suitable, relatively narrow, tolerance range may apply.

Preferably the stabilizer bars and the sheet are each formed from a single material. Preferably the stabilizer bars and the sheet are each monolithic, formed each from one-piece, although assemblages from different pieces may be considered in some embodiments.

As used herein, thermal expansion coefficients as understood herein may be said to “correspond”, if stress, distortions, etc caused by temperature changes expected across normal hospital settings do not lead to appreciable image quality drop when the grating assembly is used in imaging.

In embodiments, the thermal expansion coefficient of the sheet corresponds to a thermal expansion coefficient of the grating tile.

In embodiments, the sheet and the stabilizer bar members are formed from the same material.

In embodiments, the sheet is formed from glass.

In embodiments, the stabilizer bar members are formed from glass.

In embodiments, the glass is at least in part (preferably wholly of) borosilicate glass.

In embodiments, the glass is tempered (hardened) glass.

In embodiments, a grating substrate of the grating tile includes graphite or silicon.

In embodiments, the sheet is formed as a curved surface having curvature. Thus, the sheet defines in 3D space, a section of an imaginary cylinder surface, with the at least one grating tile equally curved so as to conform with the curved sheet.

In embodiments, at least one of the stabilizer bar members is formed as a semi-cylinder or prism, with its flat face in engagement with a respective edge portion.

In embodiments, the two of the stabilizer bar members have each a curved face conforming with the curvature of the sheet, and in engagement with the respective edge portion of the sheet.

In embodiments, at least one of the stabilizer bar members having a face projecting away from the sheet and including at least one rounded corner portion.

In embodiments, the stabilizer bar members are run substantially the whole perimeter of the sheet as defined by the said edge portions.

In embodiments, a, or any, given stabilizer bar member is essentially coextensive in length with the edge portion to which it is affixed.

In embodiments, ends (end portions) of adjacent ones of the stabilizer bar members are coupled at a corner portion of the sheet defined by two adjacent edge portions.

In embodiments, the said ends of the said adjacent ones of the stabilizer bar members define a respective gap filled with a filling material.

In embodiments, the said sheet is curved, so as to define a section of a lateral surface of an imaginary cylinder, and wherein the stabilizer bar members are affixed to the face (FS) of the sheet that is proximal to an imaginary axis of the imaginary cylinder.

Thus, in all stabilizers are on the same side/face (proximal) of the glass sheet that faces the X-ray source when in use. However, alternatively, stabilizers may be on different faces of sheet, or may be on the distal face of the sheet. Having all stabilizers on one and the same face of the sheet facilities manufacture.

In embodiments, the assembly includes distinct mounting brackets (such as flanges or braces, etc.) affixed to respective stabilizer bar member or edge portions, for mounting the assembly in a mounting structure (MS) of an X-ray imaging apparatus.

The brackets/brace may be formed from metal, or alloys thereof such as brass or other.

In embodiments, the thickness of the sheet is approximately 1 mm.

In another aspect there is provided a mounting structure (MS) for mounting into an X-ray imaging structure, including the assembly as per any one of the preceding claims.

In another aspect there is provided an X-ray imaging apparatus including the assembly as per any one of the preceding claims.

In another aspect there is provided a use of the assembly as per any one of the preceding claims for interferometric imaging in an X-ray imaging apparatus, in particular when imaging for dark-field or phase contrast signal.

In another aspect there is provided a method of preparing manufacture of a grating assembly for interferometric X-ray imaging, the method comprising:
providing a carrier sheet for arranging thereon at least one grating tile, the said sheet having edge portions;
providing stabilizer bar members; and
affixing stabilizer bar members along respective ones of the said edge portions.

In embodiments, the affixing includes any one or more of: i) gluing, ii) glass-soldering, iii) laser-welding. An X-ray transparent and compatible is preferably used.

In embodiments, the providing includes forming the sheet and the stabilizer bar members from the same initial material block, blank, sheet, etc. However, this may not be always preferable: instead, one or more of the sheet and one or more of the stabilizers are prepared from different blocks, blanks, or other initial material assemblies.

In embodiments, the said material is glass.

In embodiments, the method further comprises administering a filling material into one or more gaps that are left between adjacent ones of stabilizer bar members when to affixed.

In another aspect there is provided a method of manufacture of a grating assembly for interferometric X-ray imaging, the method comprising the said preparatory method, and further comprising affixing or depositing the at least one grating tile (especially, plural such grating tiles) on the carrier sheet having the stabilizer bars so affixed.

The tile(s) is/are affixed on a face of the sheet, that is when in use proximal or distal to the X-ray source The grating tile(s) are so affixed to the face, away from the sheets edge portions.

In sum, what is proposed herein is an improved grating assembly, with enhanced mechanical stability, in particular (but not only) for use in tiled and focused interferometric X-ray based imaging.

In previous designs, the requisite mechanical stability of the grating assembly was solely caused by using glass as the material for carrier sheet. Thus, in order to have sufficient stability to keep the grating tiles (preferably made from graphite or silicon) substrates bent to the required curvature, previously a relatively thick glass carrier was needed. As proposed, herein the additional stabilizer bars are glued or otherwise affixed to the carrier sheet, providing additional stability, thus allowing the sheet to be made in embodiments from thinner glass, leading to cost and weight savings. Whilst thinner, the sheet thanks to the stabilizer bars can overcome the urge of the grating tiles to relax back into their planar shape, thus safely maintaining grating tiles and sheet in curved form, as required.

Thanks to the higher mechanic stability, the grating assembly requires fewer mounting points/bracket when used in the imaging apparatus.

The proposed method uses latest technology in glass manufacturing and machining so that also the stabilizer bar members can be arranged in glass. Preferably, the stabilizer bar elements and the carrier sheet are made from massive glass, without other materials. The additional stabilizer bar members from glass can be glued to edge/outer margin portions of the glass carrier in order to create stability not only via the glass carrier itself. By using glass for these additional stabilizer bar elements, it is ensured that the entire structure does not suffer from unwanted bending, torsion or shearing stress that may be caused by temperature changes of the environment in which the grating assembly us stored or used.

The proposed design using the stabilizer bar elements affords the following additional advantages:
By using additional stabilizer bars affixed to edge portions of the glass carrier sheet, the overall grating assembly has increased stability, which allows using thinner glass carrier, which in turn makes the imaging more dose efficient;
Use of the additional stabilizer bars affixed to the carrier sheet allows hardening the glass carrier by tempering. Hardening allows to reduce the thickness further, because an undesirable side-effect of hardening, namely brittleness, is compensated for;
The design is overall easier to manufacture, and thus can be produced at lower cost;
The design allows for a better handling of the grating assembly and/or of the mounting structure in which it is mounted;
As higher precision can be achieved than before.

In embodiments, the method of manufacture of the grating assembly, further comprises the steps of:
arranging a grating tile on a curved surface of a mold so that the grating tile assumes a curvature, and then
applying the (curved) grating tile to a curved carrier sheet/substrate, or applying the curved carrier substrate to the grating tile, so that the curvature of the tile conforms with a curvature of the carrier sheet. Preferably, plural tiles are so arranged and the curved carrier substrate is then applied, or being applied to, at once. The curved surface of the manufacturing device may be concave.

Thus, although the individual grating wafers (which will be referred to herein as “grating tiles”) are natively flat as made, are held bend and are then applied to the carrier sheet to achieve the required overall curvature of the sheet-grating tiles system.

In embodiments, a thermal expansion coefficient of the carrier substrate corresponds to a thermal expansion coefficient of a grating substrate.

In embodiments, the carrier substrate includes glass or graphite.

The carrier substrate may be obtained by bending a heated glass sheet over a (positive) mold. The mold may be made from Aluminum or other metal or other non-metal material. Mold may be obtained with the required curvature through additive manufacturing, 3D print, CNC machining etc. A graphite carrier substrate may be obtained by CNC machining.

In embodiments, the glass is at least in part borosilicate glass.

In embodiments, the grating substrate includes graphite or silicon.

The material combinations of the carrier substrate and the grating substrate envisaged herein in include “glass (carrier substrate) on graphite (grating substrate)”, “glass on silicon” or “graphite on graphite”, or “graphite on silicon”. Out of the with-glass combinations, glass on silicon may be preferred as one may find a glass material with suitably thermal expansion coefficient that matches silicon better than graphite. In some embodiments, the stabilizer bars may be made from a Nickel-Iron alloy, such as Invar (FeNi36, also referred to as 64FeNi).

In embodiments, the method, comprises, prior to the applying step, a step of arranging the grating tiles on a curved surface of a manufacturing device.

Whilst use of glass as described above is preferred, the principles described herein are also applicable for grating assembly manufactured from materials other than glass, such as glass in combination with other materials, or in embodiments of grating assemblies where, instead of glass, other materials are used, such as carbon, graphite, silicon, or others still, as required.

### BRIEF DESCRIPTION OF THE DRAWINGS

Exemplary embodiments of the invention will now be described with reference to the following drawings, which are not to scale, wherein:

FIG. 1 shows a schematic diagram of an interferometric X-ray imaging apparatus for example for phase contrast or dark field imaging;

FIG. 2 shows a perspective view for grating assembly assembled from grating tiles;

FIG. 3 shows a perspective view of a curved grating assembly including edge portions having affixed thereto stabilizer bars as envisaged herein in embodiments;

FIG. 4 shows views on the grating assembly with stabilizer bars in various embodiments;

FIG. 5 shows such a grating assembly mounting structure; and

FIG. 6 shows a flow chart of a method of manufacturing such grating assembly.

### DETAILED DESCRIPTION OF EMBODIMENTS

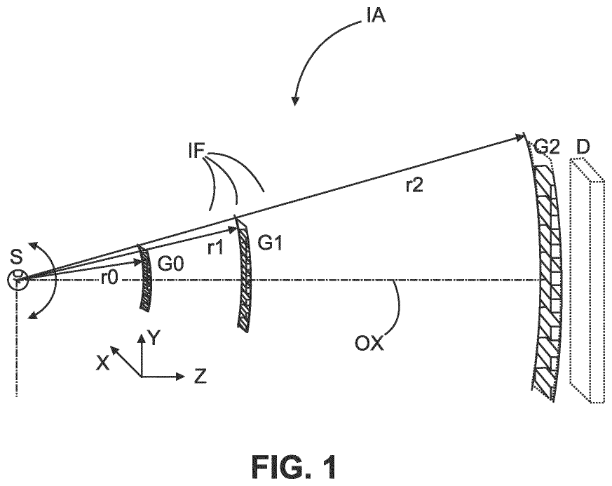

With reference to FIG. 1, this shows a schematic diagram of components of an interferometric X-ray imaging apparatus IA.

The apparatus IA includes an x-radiation source S and an x-radiation sensitive detector D. There is an examination region between the X-ray source and the detector D where the object to be imaged (not shown) usually resides during imaging.

The imaging apparatus IA further includes an interferometer IF. Thanks to the interferometer IF, at least a part of which is also arranged in the examination region between the source S and the detector D, the imaging apparatus is capable of providing not only absorption images, but also phase contrast and/or dark field images. The latter two have been found to provide additional diagnostic value. The latter two images harness different contrast mechanisms than absorption imaging, in that they allow imaging the amount of phase change or small angle scatter, respectively, as caused by the object to be imaged, e.g., patient tissue. For example, in the medical field as mainly envisaged herein, phase contrast imaging allows better imaging of soft tissue where contrast is usually too low for absorption-based imaging. Dark field images on the other hand have been found to provide good contrast for microstructures and may be hence useful in the detection of early stages of breast cancer.

In embodiments, but not necessarily in all embodiments, the interferometer IF includes three grating structures referred to herein as “G0”, the source grating, “G1”, the phase grating, and “G2”, the analyzer grating. The source grating G0 is optional and is used to produce coherent x-radiation at the source S. In other words, if the source S produces native coherent radiation, the grating G0 may not be required. The source grating G0 and the analyzer grating G2 are absorption gratings whilst the grating G1 is, as the name suggests, a phase grating.

In operation, x-radiation emanates from the source S, interacts with matter in the imaged object and the interferometer to cause a diffraction or a Moiré pattern which can be detected at the detector D. Signal processing can then be used to analyze this pattern to compute dark field or phase contrast imagery and, if desired, conventional absorption imagery.

The gratings are in general oblong or square shaped and are preferably as shown in FIG. 1 focused towards the focal spot of the source. In other words, the gratings G0, G1 and G2 are curved, in particular, form respective sections of lateral surfaces of three imaginary concentric cylinders with radiuses r₀, r₁ and r₂, respectively. Having the gratings focused in this manner affords better signal efficiency. In FIG. 1, directions X, Y represent the two spatial dimensions of the gratings whilst direction Z is the imaging direction parallel to the optical axis OX of the system IA.

The imaging apparatus IA mainly envisaged herein is of the full view type in that the spatial dimension (when viewed in perspective view along the optical axis) of grating G2 corresponds to the shape and size of the radiation sensitive surface of the detector D. In certain applications envisaged herein, such as chest imaging, the detector and hence the G2 is quite large, up to 50×50 cm² or even larger for non-medical applications such as full body screeners. In other words, in full-view systems IA, the analyzer grating G2 has about the same size as the detector D. As mentioned earlier in the background, producing such full-view gratings in large sizes is not currently possible. Instead, the analyzer grating G2 needs to be assembled or “stitched” together from smaller grating tiles GT so as to build the analyzer grating G2 in the required size. Similarly, the G1 grating may be sizable, though smaller than G2, but may still benefit from a similar tiling of such grating tiles, configured as phase gratings, as opposed to absorbing grating tiles GT for grating G1.

Manufacture of the grating tiles GT themselves are outside the scope of the present disclosure and has been described elsewhere in detail such as Mohr J et al in “High aspect ratio gratings for X-ray phase contrast imaging”, published AIP Conf. Proc., vol. 1466, pp 41-50 (2012), and David C, et al in “Fabrication of diffraction gratings for hard X-ray phase contrast imaging”, Microelectron. Eng., vol 84, pp 1172-7 (2007). Grating tiles GT for use in the context of the present disclosure can be currently obtained and are usually square or oblong shaped and have a thickness of about 1000 microns (in Z direction). As such, the grating tiles GT themselves are planar and include two surfaces, a proximal and a distal surface, the proximal being closer to the source S when in use along direction Z. The proximal surface of the grating tile may also be referred to herein as the “lower surface” whilst the other, opposing, distal surface, as the “upper surface”.

A grating tile GT for absorber grating G2 (or G0) includes a grating substrate or main body that has the top (or upper) surface and the lower surface. The upper surface of the grating substrate is ruled to include a set of parallel rulings or grooves with ridges left between any two neighboring grooves. These grooves can be obtained by etching or lithographic techniques as previously described. In addition, the grooves are partly or fully filled with a high Z material such as gold or lead to so obtain a set of parallel grating lamellae of the grating tile GT for G2. The grating substrate itself is made from a suitable material such as silicone or graphite. Similar grating tiles without such filing with high-Z material may be required for phase grating G1. “Grating tile GT” may be used herein as a generic reference to a phase or absorber grating, depending on their use as G1 or G2, respectively. The principles described herein are mostly relevant to the gratings G1, G2 with their large surface area, than they are for the smaller grating G0 (but may still be used there). Therefore, we will mostly, if not exclusively, focus herein on G1 or G2, in particular on the largest grating G2.

The proposed manufacturing method, and related device, allow efficient production of curve grating assemblies from existing planar grating tiles to so build focused gratings, in particular absorption or phase gratings, of any desired size and or use in interferometric X-ray imaging.

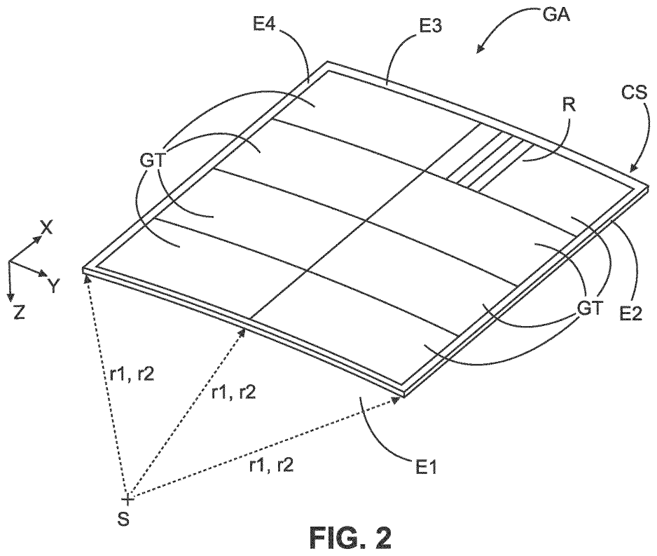

One such grating assembly GA, such as G1 or G2, that can be built with the proposed method is shown schematically in FIG. 2. Thus, the term “grating assembly GA” will be used herein as a generic reference to G0, G1 or G2, each including a tiling from grating tiles GT. However, such a generic reference to either G1 or G2 is preferred herein. The grating example GA includes a plurality of grating tiles GT (8 in number in the example of FIG. 2) arranged in a matrix layout. The tiles GT have, in one direction, say X, their ruling patterns aligned in parallel and have, along the other direction, Y, their ruling patterns aligned in registry with each other, that is, groove at groove and ridge at ridge.

The grating tiles GT are fixed to a curved carrier substrate CS. In particular, the grating tiles are glued to the carrier substrate CS. The curvature of the carrier substrate CS corresponds to the required curvature of the imaginary lateral cylinder surface with radius r2. The carrier substrate CS with the glue (not shown) applied thereto forces the gratings to conform to the required curvature as the gratings themselves are naturally planar as mentioned earlier.

It is desirable to maintain the X, Y-alignment of the gratings' ruled surfaces during a range of operating conditions of the imaging apparatus. Applicant has found that this can be achieved by having a thermal expansion coefficient of the carrier substrate CS correspond, in particular equal or very similar, to the thermal expansion coefficient of the grating substrate of the tiles GT. In particular, when the gratings tiles GT are from silicon or graphite, it is advantageous to have the carrier substrate CS made from glass, in particular pure glass. More specifically, a curved sheet of floating glass, or more particular borosilicate glass is used with a thermal expansion coefficient equaling that of graphite or silicone. Other material combinations for the carrier substrate and the grating substrate can be used provided that their thermal expansion coefficients are essentially equal or are within a tolerable range of each other. Preferably the relative difference in thermal expansion coefficient is up to, or less than 20%. More preferably still, the absolute difference between the thermal expansion coefficients is up to or less than 1*10⁻6/K°.

The carrier substrate CS is, in some embodiments, a curved glass sheet having the required curvature or bend radius of r1 or r2 with its size (area surface) and shape equaling (in perspective view along direction Z) the size and shape of the radiation sensitive surface of the detector D.

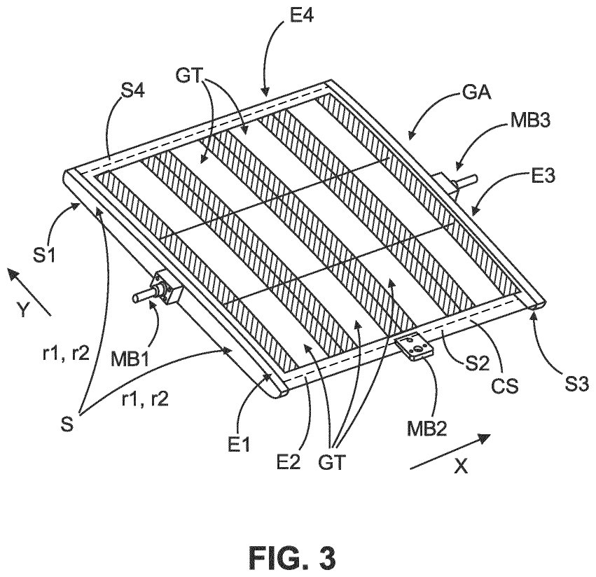

In addition to the components and set-up shown in FIG. 2, the grating assembly GA further includes additional stabilizer parts S1-S4 (not shown in FIG. 2 for clarity) that are attached to edge or margin portions E1-E4 of the, preferably glassy, carrier sheet CS as illustrated in perspective view of FIG. 3 to which reference is now made.

The view afforded by FIG. 3 is that from viewpoint outside the imaginary cylinder, with a view on the distal face of the carrier sheet CS where the grating tiles GT are deposited, in a manner described for example in Applicant's WO 2021/0099274.

The stabilizer parts S1-S4 are different and distinct from the carrier sheet CS's edge portions E1-4, and are attached thereto in a separate and dedicated manufacture step as will be explored herein in more detail. Preferably, the stabilizing elements S1-S4 are themselves each made of glass, if the carrier sheet CS is so made. Preferably still, the stabilizing elements S1-S4 have generally each an elongated form, so are longer than they are wide thus forming bars, each affixed to a respective one of edge portion E1-3 as per FIG. 3. On account of their elongated form, the stabilizing elements S1-S4 will be referred to herein as stabilizer bars S1-S4, with the understanding that embodiments of varying cross-section are specially envisaged herein. The stabilizer bars S1-S4 are operative herein to stabilize the grating assembly, in particular the sheet CS carrying the grating tiles GT, for better stiffness, in particular for enhanced torsion, or vibration resistance, etc.

There is in general one single such stabilizing bar S1-S4 affixed to a respective one of the edge portions E1-E4. Thus, there is a single stabilizing bar to each single edge. Thus, if the carrier sheet has, as is mainly envisaged herein, a generally rectangular shape, there are then four such stabilizer bars S1-S4, one for each edge E1-E4 to which the respective stabilizing bar S1-S4 is affixed by suitable means. Other layouts of the carrier sheet such as triangular, pentagonal, of indeed of any other polygonal shape are also envisaged herein, with the respective number of bar elements Sj as such layout may call for. Circular or oval or other layouts with curved perimeter are not excluded herein, in which case there are at least two such stabilizer elements S1-S4, which are then no longer straight bar elements, but arcuate bas, with a curvature in their longitudinal axis. However, in the following a rectangular or square layout as shown in FIG. 3 will be assumed herein, with four stabilizer bars S1-S4, with the understanding that this is not to limit the principles as described herein, and that mentioned alternative layouts are specifically envisaged herein in embodiments. It may be noted that the layout of the grating tiles GT on the carrier sheet CS need not necessarily follow the shape of the sheet CS. Whilst in the Figures herein, the matrix style layout of grating tiles GT follows the rectangular shape of sheet CS, this is an example and mainly indeed envisaged herein. However, this layout vs sheet shape correspondence, whilst mainly envisaged herein, may not apply to all embodiments. For example, the grating GT may still have the matrix/rectangular layout, but the sheet CS may have instead a triangular shape, and so on for other combinations.

The stabilizer bars S1-S4 are preferably formed of the same glass as the carrier sheet is. Borosilicate glass is preferred herein for its high level of transparency/transmittance. Borosilicate glass. Borosilicate glass has in general very low amounts of impurities, in particular of unwanted metal particles, which otherwise may cause artifacts on their own in X-ray imaging. The glass material is preferably tempered for yet greater stability. The sheet CS is preferably made from the same glass type as the stabilizer bars S1-S4 are, so both are preferably made from Borosilicate glass, preferably tempered. The preferably glassy sheet CS has a thickness in the millimeter range, such as about 1-5 mm thick, preferably about 1-1.5 mm, preferably still, 1 mm. Thus, the carrier sheet may be made very thin thanks to the stabilizing effect of the additional stabilizer bars S1-S4.

The stabilizer bars S1-S4 are affixed to the carrier sheet's edge/margin E1-E4 portions to form an embracing stabilizer structure running essentially the whole perimeter of the carrier sheet CS. This all-embracing structure provides for high level of stiffness and stability, in particular when tempered glass is used. This enhanced stiffness and stability in turn translates to improved image quality, without artifacts, when such grating assembly GS is used in the phase-contrast or dark field imaging apparatus as is intended herein.

The stabilizer bars as S1-4 form two pairs with members of each pair having identical shape whilst, members from different pairs have different shapes, owing to the glass carrier sheet having curvature only in one spatial dimension Y, as shown in FIG. 3. Thus, one pair of stabilizer bars S1, S3 may be referred to herein as curved stabilizer bars, whilst the other two stabilizer bar S2, S4 of other pair have a generally of straight overall configuration.

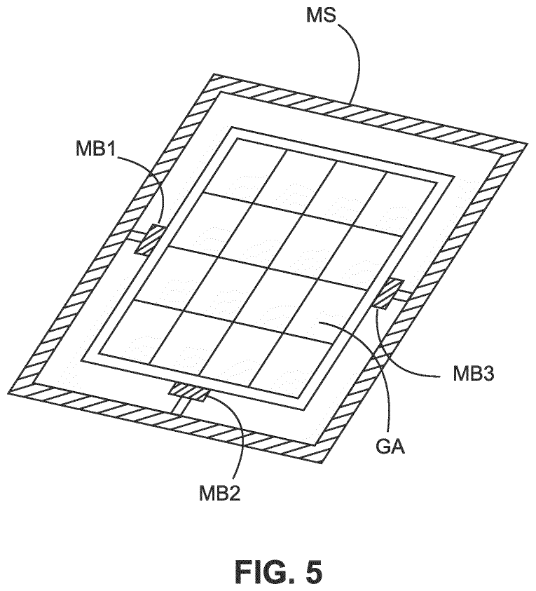

The grating assembly may further include three mounting brackets MB1-3, one for each of three of the four edges. The mounting brackets allow mounting of the completed grating assembly GA into a mounting structure MS (see FIG. 5). The mounting structure with the grating assembly in it may then be mounted into the imaging apparatus IA for use. Of note, only three mounting brackets MB1, MB2 and MB3 are required as opposed to four, thanks to the good stability of the grating assembly conferred by the affixed stabilizer bars S1-S4. Some of the mounting brackets MB1-3 may be affixed to carrier sheet's edge portion(s) E1-4 itself, whilst other(s) mounting brackets MB1-3 are affixed to the stabilizer bars as shown in FIG. 3. Preferably, one mounting bracket attaches to one edge portion, whilst the other two, to, respectively, opposed stabilizing bars of a pair.

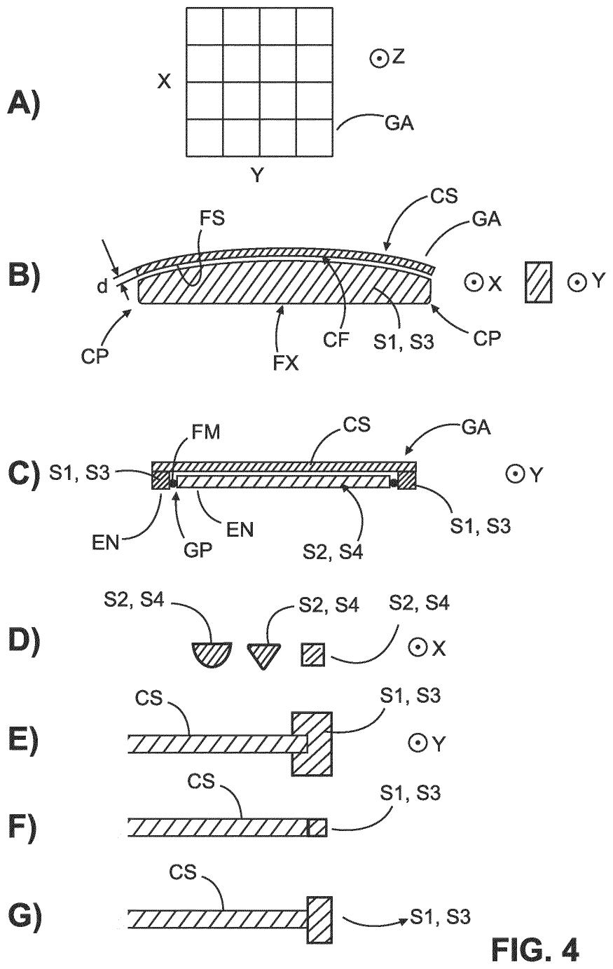

Note, in FIG. 3, the stabilizer bars S2, S4 having at least one straight/lineal face are not well visible (they are indicated as dashed lines), as in this embodiment and in the view afforded by FIG. 3, they are affixed to the proximal face of sheet CS, “behind” the sheet CS, with the proximal face facing away from the perspective viewpoint afforded by FIG. 3. A better representation is provided by view as per FIG. 4 to which reference is now made. Various embodiments of the stabilizer bars S1-S4 are envisaged herein, some of which are illustrated in various views in FIG. 4.

FIG. 4A is a schematic plan view along the imaging axis Z, perpendicular to the curved surface and the distal face of the grating assembly. Thus, the viewing direction, which corresponds to the imaging direction, extends generally into the drawing plane of the figure. Thus, the curvature of the carrier sheet CS is not discernable in this view.

FIG. 4B affords a side elevation view of the curved faced stabilizer bars S1, S3, in X direction, perpendicular to longitudinal axes of stabilizer bars S1, S3. They are both identical in shape and are arranged at opposed edges E1, E3 as shown in FIG. 3. The profile, when viewed along the straight dimension X of the carrier sheet, is generally one of a circular segment truncated at both ends, but non-truncated embodiments are not excluded herein. The said circle for defining this truncated segment corresponds to the base circle of mentioned imaginary cylinder of whose lateral surface the carrier sheet CS can be conceptualized as being part of. One or both corner portions CP of the profile that point away from the carrier sheet CS are rounded as shown in FIG. 4B. This allows better sustaining impact with reduced likelihood of compromising integrity of each of the, preferably glassy, stabilizer bars S1, S3. The respective curved face CF of each circular segment bar member S1, S3 is, when affixed, in engagement with the proximal face FS of the glass sheet. Thus, the curved face CF of stabilizer bar S1,S3 conforms in curvature with that of the carrier sheet when so affixed. Stabilizing bar S1, S3's projecting or proximal face FX, opposite the curved face FS, is preferably straight-edged, extending between the rounded portions CP as shown in FIG. 4B. Such straight-edged face FX facilitates processing as it allows the stabilizer bar S1,S3 to be held more securely in place when handled. However, doubly-curved embodiments of the curved-faced stabilizer bars S1, S3 are also envisaged, where the proximal face FX is also curved. For example, the curved faced stabilizer bars S1, S3 may have a kidney shaped profile or, when curved in opposed fashion, a lens or Vesica Piscis shaped profile when viewed along the direction X as per FIG. 4B. Having at least one such curved face, adds improved stiffness, which is desired herein. Having one face curved and the attaching face straight, strikes a useful balance between stiffness and advantageous handing in production.

FIG. 4C affords a view of the sheet having stabilizer bars in the direction Y of sheet's CS curvature, perpendicular to direction X of FIG. 4B, and thus along the longitudinal axes of the stabilizer bars S2, S4. This affords a view of the straight-edged pair of stabilizer bars S2, S4. These have in general the shape of a prism or of a semi-cylinder as shown along direction X in FIG. 4D. Thus, the cross section may either be a semi-circle, triangle or other polygon, such as rectangular, as required. Such semi-circular or triangular cross section give rise to at least one straight non-curved face, which is in engagement with the respective straight edge portion E2, E4 when the semi-cylindrical or prism like stabilizer bar S2, S4 is affixed to sheet CS as shown in FIG. 4C. Only one such bar element S2 is shown the other being understood to being identical in form and shape, and similar for the other pair S1, S3 where FIG. 4A merely illustrated one bar of that pair.

As mentioned, the four stabilizer elements when affixed run essentially together full length of the perimeter of the glassy sheet. That is, two elements of one of the pair, which may be referred to as the principal pair (in this case the curved pair S1, S3) are each co-extensive with their respective edge portion E1,E3 to which they are affixed, whilst the other pair of stabilizer bars S2, S4 are each shortened to accommodate the width of the bars of the principal pair that are each allowed to run the full length of their edge as shown in the view afforded in FIG. 4C. The reverse arrangement is also envisaged, where it is the pair of straight stabilizer bars S2, S4 that form the principal pair, at the expense of the curved pair S1,S3.

Respective end portions EN of adjacent bar elements S1, meet at corner portions of the sheet CS as defined by intersecting edge portions E1-E4. Preferably, such adjacent bar elements S1-S4 are re not abutting, but leave a respective clearance gap GP. Some or each such clearance gaps GP may be left empty, or may be filled with a filler material FM on manufacture. The empty or filled gap GP allows better absorbing any sort of vibration or other motion the assembly GA may subjected to, or of some vestigial expansions that may be experienced by the assembly GA due to temperature gradients. The views of FIG. 4E-G illustrate alternative constructions for, in particular, the straight phase stabilizers S2, S4.

For example, in the embodiment of FIG. 4E the two stabilizer bars S1, S3 from the straight-faced pair have a groove in it for embraced engagement with the respective edge portion E1, E3 from above and below, i.e., to contact proximal and distal face of the sheet CS, with the groove receiving the, possibly narrow, front face of the edge proper of sheet CS, which is perpendicular and in between distal and proximal face of sheet CS. This affords good stability, but at the expense of a more complex manufacturing process by milling for example.

Instead of having the stabilizers attached to the edge portions at distal and/or proximal marginal face portions of the sheet CS, such stabilizer bars S1 S3 may be affixed to the said front face, perpendicular to the proximal and distal face, of the sheet CS, as shown in FIG. 4G. A thickness d in radial direction of the stabilizer bars S1, S3 may be so chosen, to give rise to a flush design as shown in FIG. 4F where the stabilizer thickness corresponds to the thickness of the sheet. Alternative, there are projecting margins of the bars S1, S3 projecting away from either the proximal or distal face of sheet CS, or from both, as shown in FIG. 4G. In particular, the designs as per FIGS. 4F, 4G may be applicable if the glass sheet has a somewhat thicker dimension.

All stabilizer bars S1-S4 as shown in FIG. 3 are arranged on the proximal face of sheet, projecting towards the X-ray source XS when in use. Whilst this arrangement affords good stability and is useful, in other embodiments all stabilizer bars S1-S4 are arranged instead on the distal face, away from the source XS. “Hybrid” arrangements are also envisaged, where some stabilizer bars S1-S4 are arranged on both faces, for example, one pair on one face, the other pair on the other of sheet CS's face. If the curved pair S1, S3 is arranged on the distal face of sheet CS, their profile is then inverse to the one shown in FIG. 4A: instead of having the curved face being convex as in FIG. 4A, a concave design may now be called for which now engages the sheet on its distal face when affixed, with the straight edged face now projecting into space away from location of source XS.

FIG. 5 affords a perspective view on the described grating assembly having to its edge portions E1-E4 affixed as described stabilizer bars as 1-4, and mounted in a mounting structure frame MS at the three mounting brackets MB1, MB2 and MB3.

Advantageously only a small number, namely only three, mounting brackets are required, as opposed to four such brackets as one may have expected. This allows saving weight and cost of manufacture, thanks to the enhanced mechanical stability of the proposed grating assembly afforded by stabilizer bars S1-S4.

The mounting frame MS is in distinction to the stabilizing frame formed by the collection of all four or more stabilizer bars that run the perimeter of the glass sheet CS. The mounting frame MS allows mounting of the complete grating assembly (including the stabilizer bars S1-S4) in the imaging apparatus. The mounting structure MS may also allow adjustment of pose of the grating assembly GA when mounted. Thus, the mounting frame MS may allow adjusting for spatial alignment of the grating assembly in respect to source XS or detector D, or in respect to the other one or two gratings. For example, pitch, yaw, roll, or any two of them, or only one thereof may be adjustable in the frame MS, as required.

It will be understood that the above as has been described mainly with respect to embodiments where stabilizer bars and the glassy carrier sheet are both made from glass. Whilst this is the preferred embodiment herein, other embodiments are also envisaged where the stabilizer bars and/or the sheet are made at from sufficiently stiff materials that have both substantially the same thermal expansion co-efficient as the grating tiles.

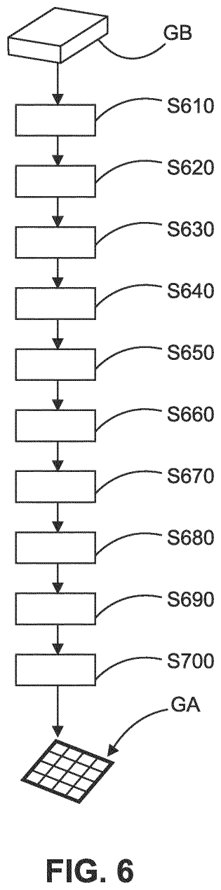

In such embodiments it is either the carrier sheet that is made from glass but not the stabilizers or the other way around the stabilizers are from glass but not the carrier sheet. In other embodiments neither the sheet nor the stabilizers, or at least one of the stabilizers, are made from glass. For example, the stabilizers may be made instead from graphite or silicon, Invar, or other material that has substantially the same thermal expansion co-efficient as the carrier sheet CS, with the grating tiles deposited/affixed on the carrier sheet CS. Applicable ranges for the thermal expansion co-efficient as provided below at FIG. 6, to which reference is now made.

FIG. 6 shows a method of manufacture of the grating assembly as discussed above, for use in phase contrast imaging or DAX imaging with X-ray. The method is applicable in particular to the G2 grating, but may also be used for the G1 grating, and even to source grating G0 is required.

At preliminary step S610, raw material GB is provided or procured, such as a block or plate of such material, such as a glass block or plate, or graphite or silicone block or plate. The raw material will be simply referred to herein as “block”. Glass is preferred herein, however a reference below to “glass” is exemplary, and other such materials may be used herein instead.

At step S620 the carrier sheet CS is provided. For example, at step S620, from this glass or other material block GB, the curved carrier sheet is cut out by milling for example, or by any other glass cutting technique, or machining. Such cutting is preferred for non-glass materials however.

At step S630 the stabilizer bars S1-S4 are provided. In some embodiments, the glass block is so dimensioned that the leftovers after the cutting out of the carrier sheet is sufficient to allow cutting out (e.g., by milling or other process) the four or more stabilizer bars S1-S4 as described above, depending on the number of edge portions of the glass sheet. Preferably however, the stabilizer bars and the carrier sheet are formed from different glass stock, such as blocks, a sheet(s) (that is thicker than the intended thickness of the carrier sheet), or bar stock, the latter in particular for the straight-edged pair of stabilizer bars S2,S4.

The order of steps S620 and S630 may be reversed.

As said, instead of glass, any other raw material may be used that has a thermal expansion coefficient that substantially equals that of the material from which the grating tiles are made. Preferably the grating tiles are made from silicon, carbon. The combination of silicon for the grating tiles and glass for the carrier sheet is preferred. Whether or not glass is used (and this is preferred), the material for the stabilizer bars and for the carrier sheet is preferably the same, optionally from the same block or blank material. In more detail, the thermal expansion coefficients of the stabilizer bars and the carrier sheet are preferably within a difference of up to 1*10⁻⁶/° K (a reference temperature, such as 20° C.). It has been found that having an absolute difference in this range allows using the grating assembly without appreciable loss of image quality within operating temperature range as may be typically encountered in hospital settings in most parts of the world. A relative difference of up to and including 20% is also envisaged in some embodiments,

It may be difficult, or undesirable, to cut the sheet and the curved stabilizer in curved form, especially for glass. Thus, as an alternative, step S620 of providing the sheet may include cutting the carrier sheet as a planar sheet from the block, and then, in a further sub-step, pre-bending the planar preferably glass sheet to the desired curvature over a mold (such as metal block, aluminum or other, non-metal, such as graphite) under heat, as for example described in Applicant's WO'274 cited above.

The above-described pre-bending over a mold may also be applied to step S630 of providing the curved pair of stabilizer bars.

The curvature is a function of the intended imaging geometry of the imaging apparatus in which the grating assembly is to be used. In particular, it is a function of the distance between the X-ray source and the grating assembly when in use.

However, it will be understood that having the grating assembly curved, as is indeed preferred herein, is optional. The grating assembly may be instead planar and none of the above-mentioned steps in relation to curvature, bending etc, are needed.

At optional step S640, the so prepared components, that is the, preferably glassy, carrier sheet and optionally the suitable number of (glassy) stabilizer bars, are then glass tempered (hardened) for better stability.

Preferably, it is only the carrier sheet that is tempered and not the stabilizer bar elements. Thus, the non-tempered (or tempered) glassy stabilizer bar elements S1-S4 allow off-setting for a possible brittleness, which is an unwanted side-effect of the tempering of the carrier sheet, at the benefit of using yet thinner glass for the carrier sheet.

At step S650 the stabilizer bars are then affixed to the edged portions of the carrier sheet as shown above. In general, the step S650 for affixing the stabilizer bars to the edge/margin portions of the carrier sheet may include any one or more of glass-soldering, glass laser welding or gluing, preferably with X-ray compatible glue. Affixing by clamping or bolting may also be contemplated in some embodiments but is less preferred. If material of other than glass is used, such as graphite, silicon, etc., appropriate joining/affixing techniques may be used, such as gluing, welding, etc., taking the material specific properties into account.

In step S650, the stabilizer bars may be laid out on a worktop surface, to follow the boundary of sheet. This can be done easily with straight-edged embodiments as discussed above in FIG. 4. A holding mold may be needed to hold in place curved faced embodiments, S2,S4. Glue may then be applied, and the sheet is urged into contact with the so arranged bars S1-S4, for example from above. Depositing bars S1-S4 from above on the underlying sheet may also be an option. In terms of efficient processing, it may be advantageous to have all stabilizer bars S1-S4 affixed on the same face (such as shown in FIG. 2), but this need not be so in all embodiments.

At step S660 the grating tiles are then (after step S650) applied to the distal face of the carrier sheet CS, for example as described in Applicant's WO'274. For example, grating tiles are held at the correct curvature on a mold, and the sheet with the stabilizer bars is then urged (“upside-down”), with its distal face, into engagement with the so placed grating tiles. Glue may be applied first to the sheet or tiles before urging into engagement. The tiles may be held in place by vacuum. Any other manner of placing the grating tile on the carrier sheet is envisaged herein, Applicant's WO '274 merely being one example that have been shown to yield good results. Optionally but less preferred, the step of affixing S660 the grating tiles GT on the sheet CS is done before step S650 of affixing the stabilizer bars.

Method steps prior to step of applying S660 the gratings to the sheet having the stabilizer bars may be considered herein a preparatory method for the overall method of manufacturing the grating assembly.

At optional step S670 a filler material to fill the gap between adjacent end portions of pairs of stabilizer bars are filled with a filling material as described above. However, pairs of the stabilizer bars are affixed to opposed faces of the sheet, there are no such gaps to fill. However, even if there are gaps, in embodiments such gaps may remain empty in some embodiments.

At an optional step S680, the two, three or more mounting brackets are affixed to the edge portions and/or the stabilizers as required. These can be fixed by gluing, clamping or bolting, as required. Optionally, one or more of the brackets are so affixed before affixing S650 the stabilizer bars. The mounting brackets are preferably from metal or metal alloys, preferably copper-based, such as brass, or other, such as glass, or as required. Copper facilitates the gluing process.

At step S690 the so finished grating assembly is then provided for use. For example, this may include mounting in an optional step the grating assembly using its brackets. For example, the grating assembly may be mounted in a mounting structure of the imaging apparatus.

In an optional downstream step S700, the grating assembly, when so mounted in the mounting structure in the imaging apparatus, has its posture adjusted for alignment with detector or other grating assemblies, or other components of the imaging apparatus, if required.

The proposed method allows efficiently assembling a highly stable grating assembly GA of any required size by combining or stitching together a required number of grating tiles in a matrix structure or layout. Initially, the grating tiles, each an absorbing or phase grating in itself, is usually planar or of a natural curvature other than the required one of r1 or r2, but are then bent into the required curvature for use in the proposed method. The grating tiles are in general of oblong or square shape, however other shapes are also envisaged herein. The grating tiles GT are not necessarily all of the same shape and/or size.

The thermal expansion coefficient of the filler material and the glue will be different from that of the carrier sheet CS and grating tiles. However, this does not interfere adversely as the glue has been observed to form a “floating” buffer or cushion between the carrier CS and the gratings, thus avoiding misalignment that otherwise may be caused by certain temperature gradients.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope. Reference signs herein may include alphanumeric characters, in particular a string of letters in capitals

1. A grating assembly (G0-G2) for interferometric X-ray imaging, comprising:
a carrier sheet having deposited thereon at least one grating tile, the sheet having edge portions and a thermal expansion coefficient; and
distinct from the sheet, stabilizing bar members affixed along respective ones of the edge portions, wherein the thermal expansion coefficient of the stabilizer bar members corresponds to the thermal expansion coefficient of the sheet.

2. The assembly of claim 1, wherein the thermal expansion coefficient of the sheet corresponds to a thermal expansion coefficient of the grating tile.

3. The assembly of claim 1, wherein the sheet and the stabilizer bar members are formed from the same material.

4. The assembly of claim 1, wherein the sheet is formed from glass, and wherein the stabilizer bar members are formed from glass comprising borosilicate glass.

5. The assembly of claim 1, wherein at least one of the stabilizer bar members is formed as a semi-cylinder or prism, with a flat face in engagement with a respective edge portion.

6. The assembly of claim 1, wherein two of the stabilizer bar members have each a curved face conforming with the curvature of the sheet, and in engagement with the respective edge portion of the sheet.

7. The assembly of claim 1, wherein the stabilizer bar members are run substantially an entire perimeter of the sheet as defined by the edge portions.

8. The assembly of claim 1, wherein the sheet is curved, so as to define a section of a lateral surface of an imaginary cylinder, and wherein the stabilizer bar members are affixed to a face of the sheet that is proximal to an imaginary axis of an imaginary cylinder.

9. The assembly of claim 1, further comprising distinct mounting brackets affixed to a respective stabilizer bar member or the edge portions, for mounting the assembly in a mounting structure of an X-ray imaging apparatus.

10. (canceled)

11. (canceled)

12. A method of preparing manufacture of a grating assembly for interferometric X-ray imaging, the method comprising:
providing a carrier sheet for arranging thereon at least one grating tile, the sheet having edge portions;
providing stabilizer bar members; and
affixing stabilizer bar members along respective ones of the edge portions.

13. The method of claim 12, wherein affixing includes at least one of i) gluing, ii) glass-soldering, and iii) laser-welding.

14. (canceled)
